(19) United States
(12) Patent Application Publication
(10) Pub. No.: US 2011/0169832 A1
(43) Pub. Date: Jul. 14, 2011

(54) 3D Motion Interface Systems and Methods

(75) Inventors: David W. Brown, Bingen, WA (US); Aaron Davis, Bingen, WA (US)

(73) Assignee: ROY-G-BIV CORPORATION, Bingen, WA (US)

(21) Appl. No.: 13/004,789

(22) Filed: Jan. 11, 2011

Related U.S. Application Data
(60) Provisional application No. 61/294,078, filed on Jan. 11, 2010.

(51) Int. Cl. G06T 15/20

(52) U.S. Cl. 345/427

(57) ABSTRACT

A 3D interface system for moving the at least one digital displayed object based on movement of the at least one physical object. The 3D interface system comprises a display system for displaying 3D images, a sensor input system, and a computing system. The sensor input system generates sensor data associated with at least one physical control object. The computing system receives the sensor data and causes the display system to display the at least one digital displayed object and the at least one digital sensed object associated with the at least one physical object. The computing system moves the at least one digital displayed object based on movement of the at least one physical object.

### RELATED APPLICATIONS

This application (Attorney's Ref. No. P216349) claims priority of U.S. Provisional Application Ser. No. 61/294,078 filed Jan. 11, 2010, which is attached hereto as Exhibit A.

The contents of any application cited above is incorporated herein by reference.

### TECHNICAL FIELD

The present invention relates to the display of three-dimensional (3D) images and, more particularly, to user interface systems and methods that facilitate human interaction with 3D images.

### BACKGROUND

Technologies for viewing three-dimensional (3D) images have long been known. Anaglyph systems were developed in the 1950's to allow 3D images to be displayed in movie theaters. Modern 3D movie systems include a 3D technology developed by Dolby Laboratories for use in movie theaters, at-home systems developed for use with personal computers, such as the High-Definition 3D Stereo Solution For The Home developed by NVIDIA Corporation, and the HoloDeck holographic television developed by Holoverse, Inc. The Dolby and NVIDIA 3D display technologies may be referred to as stereo 3D display technologies and typically require the viewer to wear specialized glasses to view the displayed images in three dimensions. The Holoverse technology may be referred to as a volumetric 3d imaging system that does not require the use of specialized glasses to view the displayed images in three dimensions.

Ultrasound systems have been used for years to produce 3D images, typically in medical applications. In the article “HIGH-RESOLUTION AND FAST 3D ULTRASONIC IMAGING TECHNIQUE,” Beneson et al. describe an ultrasound imaging technique “of electronically scanning the 3D volume that utilizes 2 transmitting and 3 receiving 1D arrays”. Similarly, in the article “Volumetric Imaging Using Fan-Beam Scanning with Reduced Redundancy 2D Arrays,”Wygant et al. explores several array designs used to produce an image. o More recently, Proassist, Ltd., created a 3D Ultrasonic Image Sensor Unit, which uses a micro-arrayed ultrasonic sensor to produce a 3D image by capturing an ultrasonic wave irradiated into the air when bounced off objects.

In addition to creating an image that is viewed by a user, ultrasonic sensing technology is also commonly used in robotic systems to detect distance and depth. For example, the LEGO MINDSTORMS NXT robotics toolkit works with the 9846 Ultrasonic Sensor, which allows the robot to “judge distances and ‘see’ where objects are.” In the article “Multi-ultrasonic Sensor Fusion for Mobile Robots”, Zou Yi et al. describe a method that allows a robot to learn its environment using multi-sensory information.

However, the applicant is unaware of any technology that allows a user to interface or otherwise interact with a 3D image, either directly or indirectly to cause a physical object to move via a motion control system.

### SUMMARY

The present invention may be embodied as a 3D interface system for moving the at least one digital displayed object based on movement of the at least one physical object. The 3D interface system comprises a display system for displaying 3D images, a sensor input system, and a computing system. The sensor input system generates sensor data associated with at least one physical control object. The computing system receives the sensor data and causes the display system to display the at least one digital displayed object and the at least one digital sensed object associated with the at least one physical object. The computing system moves the at least one digital displayed object based on movement of the at least one physical object.

The present invention may also be embodied as an interactive motion system for moving at least physical controlled object based on movement of at least one physical control object. The interactive motion system comprises a display system, a sensor input system, a computing system, and a motion control system. The display system displays 3D images. The sensor input system generates sensor data associated with at least one physical controlled object and at least one physical control object. The computing system receives the sensor data and causes the display system to display at least one digital displayed object associated with the at least one physical controlled object and at least one digital sensed object associated with the at least one physical control object. The motion control system moves the at least physical controlled object based on movement of the at least one physical control object.

The present invention may also be embodied as a method of moving at least one physical controlled object comprising the following steps. Sensor data associated with the at least one physical controlled object and the at least one physical control object is generated. A 3D image is displayed, where the 3D image comprises at least one digital displayed object associated with the at least one physical controlled object and at least one digital sensed object associated with at least one physical control object. The at least physical controlled object is moved based on movement of the at least one physical control object.

### BRIEF DESCRIPTION OF THE DRAWINGS

FIG. 1 is a system interaction map illustrating an example motion interaction system of the present invention;

FIG. 2 is a somewhat schematic perspective view illustrating a first example interaction system that may be implemented by a motion interaction system of the present invention;

FIG. 3 is a somewhat schematic perspective view illustrating a second example interaction system that may be implemented by a motion interaction system of the present invention;

FIG. 4 is a somewhat schematic perspective view illustrating a third example interaction system that may be implemented by a motion interaction system of the present invention;

FIG. 5 illustrates an example system for associating a digital object with a physical object;

FIG. 6 illustrates an example system for associating a digital object with a physical end effector;

FIG. 7 illustrates a first example computing system that may be used to implement a motion interaction system of the present invention;

FIG. 8 illustrates a second example computing system that may be used to implement a motion interaction system of the present invention;

FIG. 9 illustrates a third example computing system that may be used to implement a motion interaction system of the present invention; and

FIG. 10 illustrates a first example computing system that may be used to implement a motion interaction system of the present invention.

### DETAILED DESCRIPTION

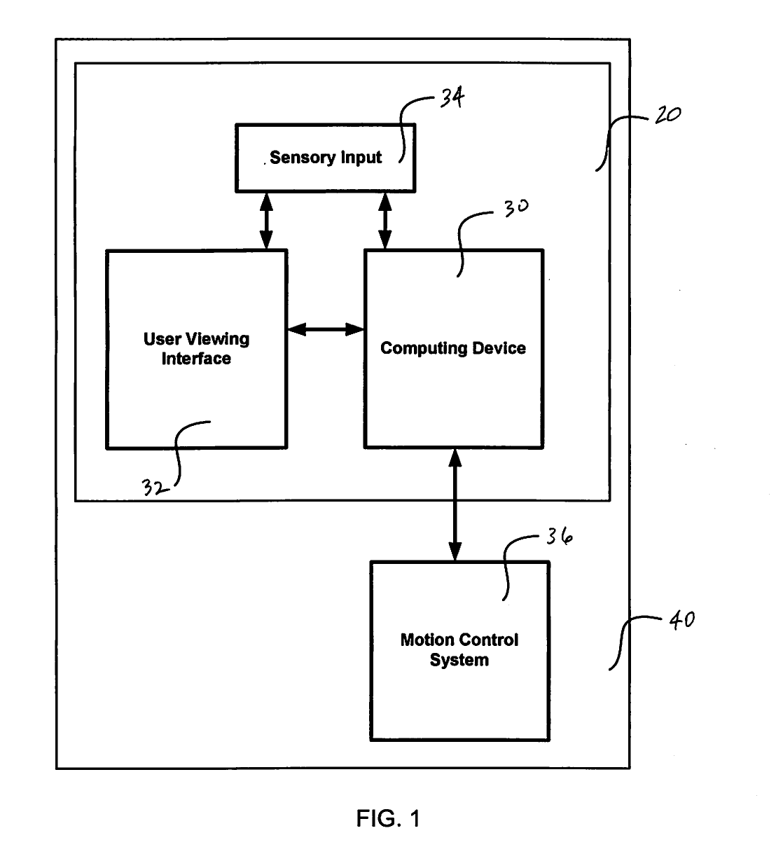

Referring initially to FIG. 1 of the drawing, depicted at 20 therein is an example motion interface system of the present invention. The example 3D interface system 20 comprises a computing system 30, a display system 32, and a sensor input system 34. Combining the 3D interface system 20 with an optional motion control system 36 forms an interactive motion system 40. The present invention may thus be embodied as the 3D interface system 20 comprising three components, units, or subsystems 30, 32, and 34 to form a user interface or as the interactive motion system 40 comprising four modules 30, 32, 34, and 36 that allow a user (not shown) to produce physical motion.

The computing system 30 is typically a processor based computing device. Example computing devices include: a personal computer, workstation, network based computer, grid computer, embedded computer, hand-held device, smart phone, smart watch (wrist watch with a computer embedded in it), smart key (key with a computer embedded in it), smart shoe (shoe with a computer embedded in it), smart clothing (clothing with a computer embedded in it), smart vehicle (vehicle with a computer embedded in it), smart ring (ring with a computer embedded in it), smart glasses (glasses with a computer embedded in it), etc. The computing system 30 works directly with the display system 32 to display information, such as 3D images or 3D video, to the user.

The sensor input system 34 is a location sensor that interacts either with the display system 32 or the computing system 30 to provide feedback describing a physical operating environment associated with the computing system 30. The location sensor system typically includes or is formed by a location sensor is a sensor used to determine one or more location points of an object at a given point in time. Example objects include a person, a person's hand, a tool, a camera, or any other physical object, etc. Example location sensors include: ultrasonic sensors, ultrasound sensors, radar based systems, sonar bases systems, etc. The sensor input system 34 may be mounted on, or embedded in, the display system 32. In either case, sensor data generated by the sensor input system 34 is transferred either directly to the computing system 30 or indirectly to the computing system 30 through the display system 32.

The computing system 30 uses the sensor data to perform a collision detection algorithm or algorithms as necessary to detect when a physical object, such as a human hand, touches a digital object, such as an object displayed in a 3D image or 3D video. In addition or instead, the computing system 30 may use the sensor data to perform the collision detection algorithm(s) as necessary to detect when a physical object, such as a human hand, touches a digitally sensed object, such an object that is overlaid on top of a live video stream of the object.

The term “motion control system” is used herein to refer to a system capable of causing physical motion. Example motion control systems include a system that uses a motion controller, simple H-Bridge type or similar chip, Programmable Logic Controller, Programmable Automation Controller to perform motion control related operations such as reading a position value, reading acceleration values, reading velocity values, setting velocity values, setting acceleration values, downloading motion related programs, or causing physical motion, etc.

One or more of the user viewing interfaces 32 may be provided. Each user viewing interface may have its own processor or processors dedicated to rendering the physical object detected by the sensor input system 34 and/or running the collision detection algorithms that allow a rendered human hand interact directly with a digital object or digital rendition of an object. Several example configurations include a first example system in which such processing occurs on the main computing device, a second example system in which such processing occurs on a specialized processor that is separate from the main processor yet runs within the main computing device, and a third example system in which the processing occurs on a processor that is embedded within the display system 32.

The 3D interface system 20 may be used to provide 3D interaction in either or both of a detached 3D interaction system or an immersed 3D interaction system.

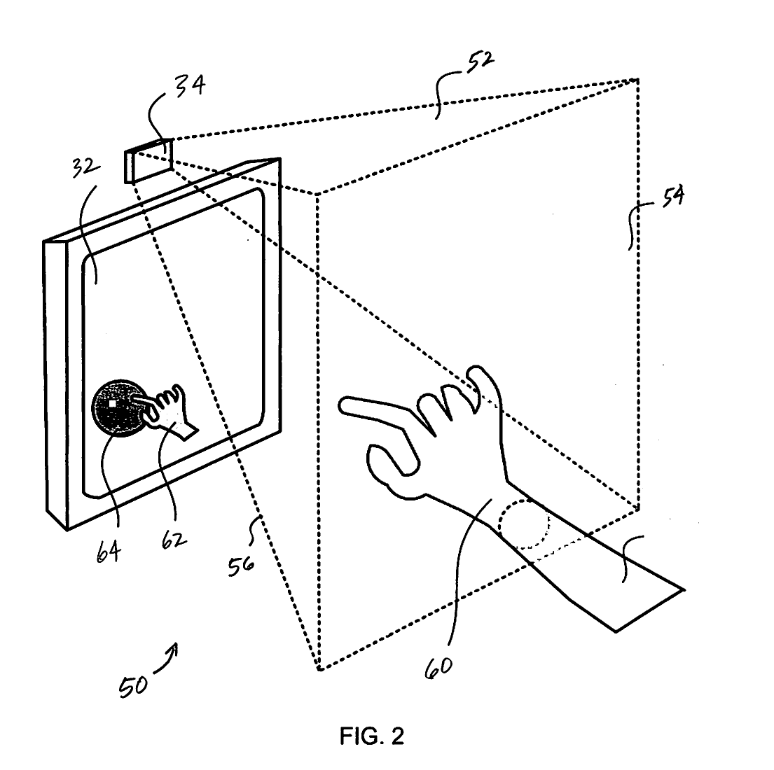

Referring now to FIG. 2 of the drawing, depicted therein is a representation of a detached 3D interaction system 50. When using detached 3D interactions, the sensor input system 34 projects a sensor field of view 52 toward the user. Optionally, a detached 3D interaction system such as the example system 50 may be configured with a cut-off plane 54 that tells the system to only process information detected within the sensor field of view 52 between location of the sensor input system 34 and the cut-off plane 54, thus reducing the amount of information to be processed and therefore optimizing overall processing. In addition to a cut-off plane such as the example cut-off plane 54, the detached 3D interaction system 50 may alternatively be configured with a cut-off volume 56 that defines a 3D space; only information sensed within the cut-off volume 56 is processed.

When a sensed object 60 is moved into the sensor field of view 52, the sensor input system 34 detects the location of the object 60 within the sensor field of view 52, generates sensor data based on this location and a reference system including the sensor field of view 52, and transfers the sensor data to the processor responsible for processing the sensor data. The sensed object 60 may be, for example, a human hand attached to the user of the system 20. The processor responsible for processing the sensor data may be the computing system 30, a processor dedicated to processing all video graphics, or a dedicated processor within the sensory input device 34. One example of a processor appropriate for processing the sensor data is sold by Proassist, Ltd, as the 3D Ultrasonic Image Sensor Unit.

The processor responsible for processing the sensor data generates a digital sensed object 62 based on the sensor data generated by the sensor input system 34. The digital sensed object 62 is the digital representation of the sensed object 60. Collision detection algorithms detect when the digital sensed object 60 ‘touches’ another digital object such as a digital displayed object 64. The digital displayed object 64 may be a representation of an object displayed in a 3D image or 3D video displayed by the display system 32. The collision detection algorithm(s) allow the physical Sensed object 60 to “interact” with the digital displayed object 64. One example of a collision detection algorithm that may be used to generate the digital sensed object 62 is the method of using hierarchical data structures described by Tsai-Yen Li and Jin-Shin Chen in “Incremental 3D Collision Detection with Hierarchical Data Structures.”

The sensor input system 34 may also be used to detect more than one digital sensed object like the example digital sensed object 62 shown in FIG. 2. In this case, the digital sensed object 62 may be configured to interact with other digital sensed objects such as in a digital rendition of a physical environment. In addition, the 3D information associated with such additional digital sensed objects may be overlaid on top of a live video, thus making it appear to the user that they are actually manipulating physical objects within a physical environment.

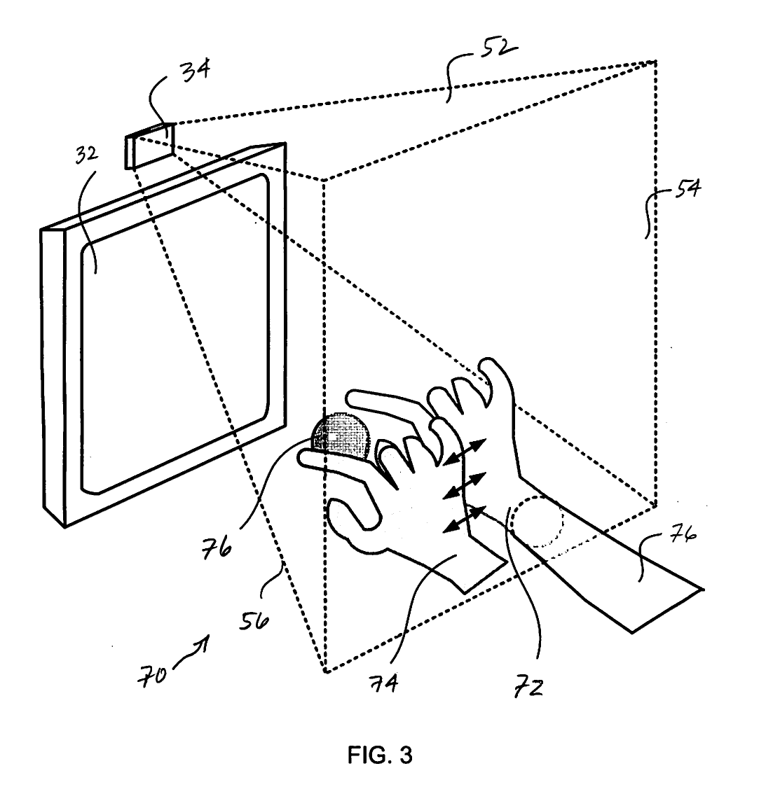

Referring now to FIG. 3 of the drawing, depicted therein is a representation of an immersed 3D interaction system 70. Like the detached 3D interaction system 50 described above, the first immersed 3D interaction system 70 defines a sensor field of view 52, a cut-off plane 54, and a cut-off volume 56 that defines a 3D space. The display system 32 of this first immersed 3D interaction system 70 may be implemented using 3D Vision technology such as the High-Definition 3D Stereo Solution For The Home by NVIDIA Corporation, a 3D Television or a technology like the HoloDeck by Holoverse.

Using the first immersed 3D interaction system 70, a sensed physical object 72 and a digital sensed object 74 representing the sensed object 72 appear to be the same thing; in particular, the digital sensed object 74 is continually overlaid on the physical sensed object 72. At least one other 3D digital object 76 may be viewed as part of a larger 3D environment.

By synchronizing the movements of the physical sensed object 72 with the digitally rendered 3D digital sensed object 74, these objects 72 and 74 appear to be as one. For example, when the sensed object 72 is part of the arm 76 of a user, the user actually sees the digital sensed object 74; in this case, a 3D digital hand appears over or is overlaid onto of the user's own hand, thus making it appear as though the user is actually interacting with other 3D digital objects 76 shown by the display system 32.

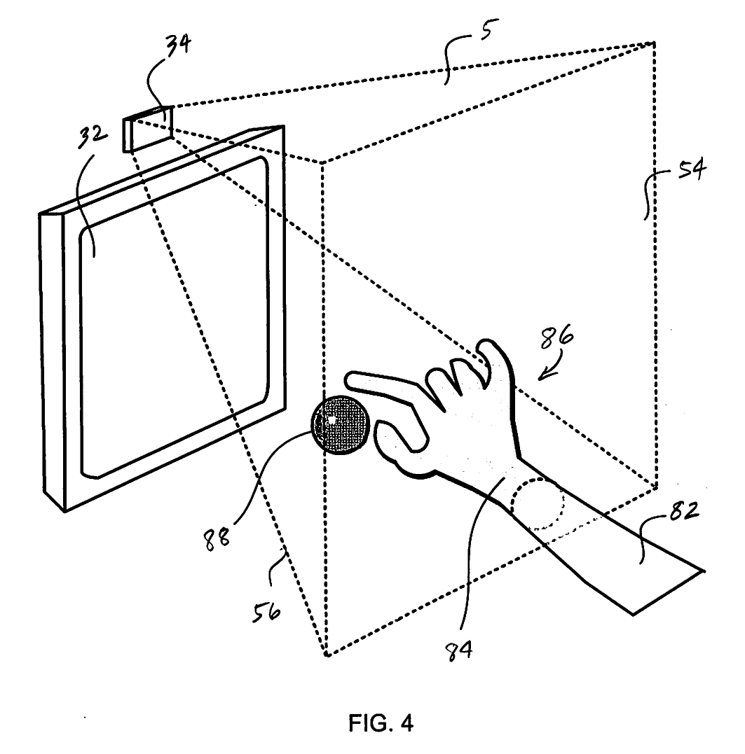

Referring now to FIG. 4 of the drawing, depicted therein is a representation of a second immersed 3D interaction system 80 and a sensed object 82. Like the detached 3D interaction system 50 and the first immersed 3D interaction system 70 described above, the second immersed 3D interaction system 80 defines a sensor field of view 52, a cut-off plane 54, and a cut-off volume 56 that defines a 3D space.

When using this second immersed 3D interaction system 80, a 3D digital sensed object 84 is overlaid on the physical sensed object 82 and becomes the 3D digital overlay object 86. As with the first immersed interaction system 70, collision detection algorithms are used to determine when the 3D digital overlay object 86 ‘touches’ other 3D digital objects 88, allowing the digital overlay object 86 and the digital object(s) 88 to to interact with one another. For example, the digital overlay object 86 may touch and push other digital objects 88 to move these other 3D digital objects 88. A ‘touch’ occurs when a collision between the two objects is detected, and a move occurs by closing the gap between the current collided objects and the desired tangent point on the digital overlay object 86 that made the original touch.

The other digital overlay objects 86 may be overlaid on top of a video stream or actual picture of the physical object itself. Such an overlay gives the user the impression that they are manipulating the touching the actual physical object. For example, as the user ‘touches’ and moves the 3D digital object 86, which is overlaid on the video stream of the actual physical object corresponding to the 3D digital objects 88, the optional motion control system 38 may then be used to move the actual physical object, which is then shown in the video/ultrasonic data stream. As the new position of the physical object is shown in the live video, the new digital representation (calculated using the sensor input system 34) of the physical objects new position is updated and re-overlaid onto the live video stream.

In addition to a human hand, other example human related physical objects that may act as a 3D digital overlay object 86 include feet, fingers, legs, arms, the head, eyes, nose, or even the entire body itself. However, again, these are merely examples: the physical object does not need to be human related.

As described above, the 3D interface system 20 may be combined with the motion control system 36 to form the interactive motion system 40. The example 3D interface systems 20 described above may be used to control a motion control system 36 embodied as described in U.S. Pat. No. 5,691,897, U.S. Pat. No. 5,867,385, U.S. Pat. No. 6,516,236, U.S. Pat. No. 6,513,058, U.S. Pat. No. 6,571,141, U.S. Pat. No. 6,480,896, U.S. Pat. No. 6,542,925, U.S. Pat. No. 7,031,798, U.S. Pat. No. 7,024,255, U.S. patent application Ser. No. 10/409,393, and/or U.S. patent application Ser. No. 09/780,316. These applications are incorporated herein by reference.

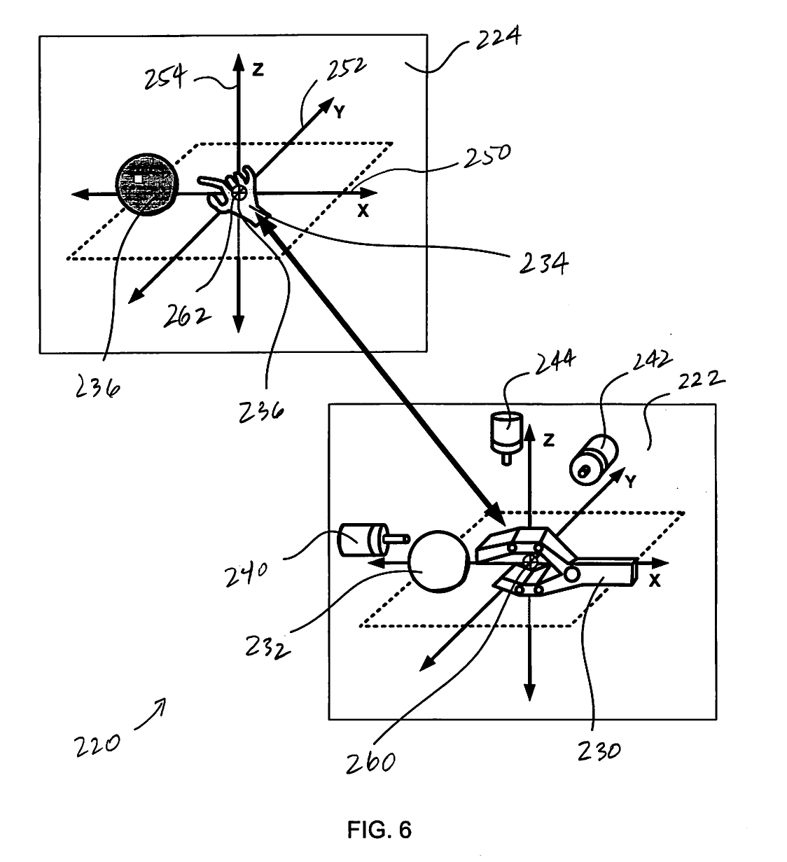

The motion control system 36 can thus be configured to cause physical motion to occur. In particular, the example motion control system 36 may be added to the 3D interface system 20 to form the interactive motion system 40. As shown in FIG. 6, the interactive motion system 40 is configured by associating the physical movement capabilities of a physical system 90 with the virtual motion capabilities of a digital system 92. Several examples of how this configuration occurs include hand entering in the movement mappings, visually entering in the movement mappings, or automatically sensing the movement mappings.

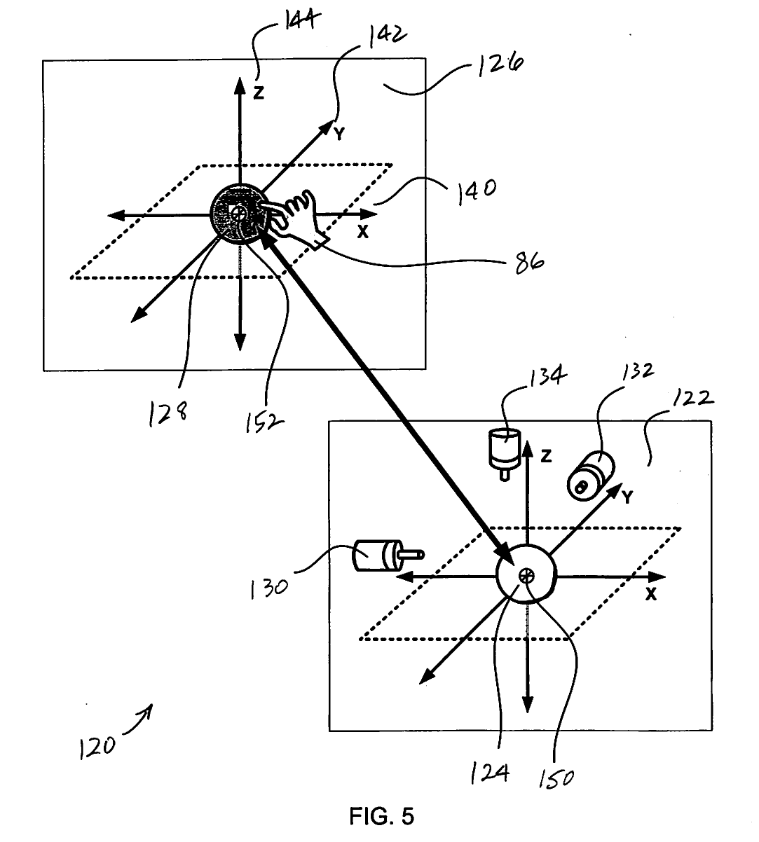

A first example system 120 for associating the physical movement capabilities of a physical system 122 comprising a physical object 124 with the virtual motion capabilities of a digital system 126 comprising a digital object 128 will now be described with reference to FIG. 5. The movement capabilities of each physical system 122 are ultimately bound by the number of mechanized axes of movement and/or a kinematic combination therein. The axes may be physical axes of motion or virtual axes of motion that comprise a combination of physical axes of motion to create a new axis of motion. The mechanized axes may either act upon the physical object 124 to move it or may be a part of the physical object 124.

More specifically, to configure the first example system 120, the movement capabilities of the physical system 122 are associated with the similar capabilities modeled in the digital system 126. For example, the X-axis motor 130, Y-axis motor 132, and/or Z-axis motor 134 are assigned to the digital object X-axis 140, digital object Y-axis 142, and/or digital object Z-axis 144, respectively, within the digital system 126. A physical reference point 150 in the physical system 122 is assigned a digital object reference point 152 in the digital system 126, thereby allowing the two systems 122 and 126 to stay in sync with one another. If a virtual axis is used, the virtual axis is associated with at least one digital axis of motion.

Once the system 120 is configured as described above, the digital object 128 is moved by ‘touching’ it using the interactive motion system 40 described above, thereby causing the physical object 124 to actually physically move. The distance, velocity, and acceleration used with the movement can be calculated using the collision detection between the objects. For example, using the terminology of the 3D interface system 20 described above, the digital object 128 corresponds to the 3D digital object 86, while the digital overlay object 86 is the user's hand. When the user's finger as represented by the digital overlay object 86 ‘touches’ another one of the other 3D digital objects 88, that finger will briefly pass into the touched 3D digital object 88. In order to compensate for this physical impossibility, the motion control system 36 moves the physical object 124 to the point where the touch point is tangent with the user's finger as represented by the display system 32. The motion control system 36 actually moves the physical object 124, and the 3D interface system 20 makes it appear to the user that they just moved the physical object 124 by moving the 3D digital object 88 displayed by the display system 32. For enhanced realistic control, when the user moves their hand faster, the physical object moves faster, etc.

A second example system 220 for associating the physical movement capabilities of a physical system 222 with the virtual motion capabilities of a digital system 224 will now be described with reference to FIG. 6. Like the mechanical system 122 described above, the mechanical system 222 The second example associating system 220 is configured to associate the movements of a physical end effector 230 and physical object 232 of the physical system 222 with those of a digital sensed object 234 and a digital overlay object 236 of the digital system 224.

To configure the system 220, the movement capabilities of the physical system 222 are associated with the similar capabilities modeled in the digital system 224. For example, the X-axis motor 240, Y-axis motor 242, and/or Z-axis motor 244 of the physical system 222 are assigned to the digital object X-axis 250, digital object Y-axis 252, and/or digital object Z-axis 254, respectively, within the digital system 224. A physical reference point 260 in the physical system 222 is assigned a digital object reference point 262 in the digital system 224, thereby allowing the two systems 222 and 224 to stay in sync with one another. If a virtual axis is used, the virtual axis is associated with at least one digital axis of motion.

In addition more complex movements, such as movements within the local coordinate system of the physical end effector 230 may be assigned to associated movements in a corresponding local coordinate system associated with the digital sensed object 234 and/or digital overlay object 236. For example, if the digital sensed object 234 is a human hand, the movements of each joint in each finger may be assigned to the movements of each joint in a physical robotic hand thus allowing the robotic hand to move in sync with to the digital representation of the sensed human hand. In another example, all of the movements of a human body could be mapped to the movements of a physical robot thus allowing the person to control the robot as if they were the robot itself.

The example 3D interface system 20 and/or interactive motion system 40 may be implemented using many different computing systems 30, display systems 32, sensor input system 34, and/or motion control systems 36 and/or combinations of these systems 30, 32, 34, and/or 36.

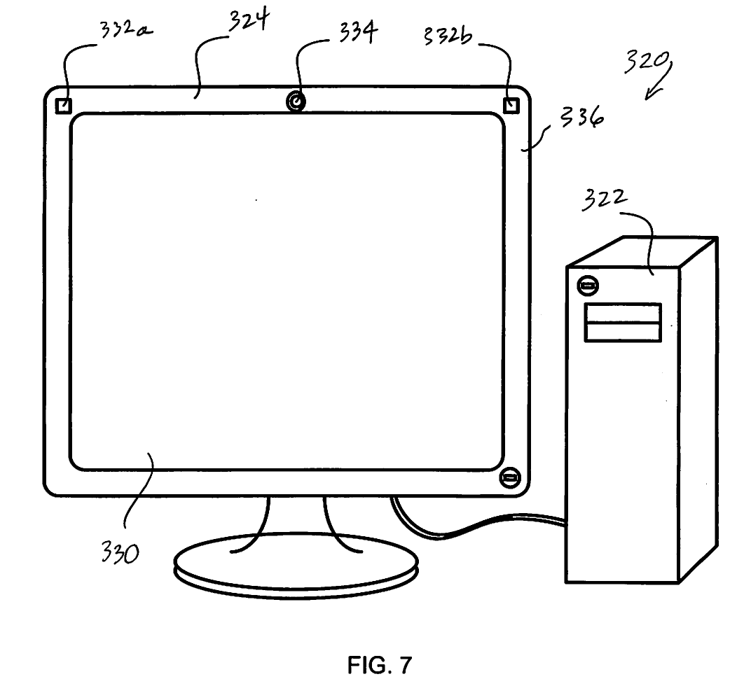

Referring initially to FIG. 7, depicted therein is a personal computer system 320 capable of implementing the 3D interface system 20 and/or interactive motion system 40 of the present invention. The example personal computer system 320 may be embodied in different forms (e.g., desktop, laptop, workstation, etc.). The example personal computer system 320 comprises a main unit 322 and a monitor unit 324. The computer system 320 may further comprise input devices such as a keyboard, mouse, and/or touchpad or touch screen, but such input devices are not required for a basic implementation of the principles of the present invention.

The main unit 322 conventionally comprises a microprocessor and volatile and/or non-volatile memory capable of running software capable of performing the computing tasks described above such as running collision detection algorithms. The main unit 322 typically also includes communications and other hardware for allowing data to be transferred between the box portion 322 and remote computers.

FIG. 7 further illustrates that the example monitor unit 324 comprises a display screen 330, one or more sensor input devices 332, and a camera 334. In particular, the example monitor unit 324 comprises left and right input sensor devices 332a and 332b that are used as part of the sensor input system 34 described above. The camera 334 may also be used as part of the sensor input system 334. The example sensors 332 and camera 334 are embedded within a monitor housing 336 of the monitor unit 324 like cameras or speakers in a conventional monitor unit. Alternatively, the location sensors 332 may be completely invisible to the user as they may be embedded underneath the monitor housing 336. The sensor input devices 332 may also be located at the bottom of the monitor housing 336, on the top and bottom of the monitor housing 336, and/or at the bottom and sides of the monitor housing 336.

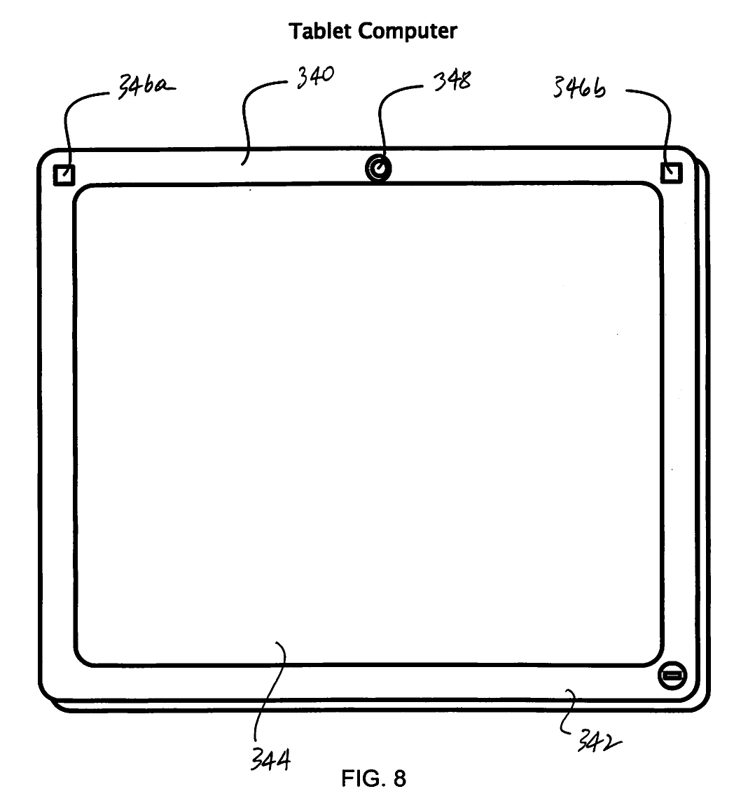

Referring now to FIG. 8, depicted therein is a tablet computing system 340 capable of implementing the 3D interface system 20 and/or interactive motion system 40 of the present invention. The example tablet computing system 340 is similar to the example personal computer system 320 described above, but the tablet computing system 340 is typically much smaller than the personal computer system 320, and the functions of the main unit 322 and the monitor unit 324 are incorporated within a single housing 342. The example tablet computing system 340 may offer touch screen and/or pen input. A laptop would have a generally similar configuration, but would typically employ a mouse and/or keypad instead of or in addition to a touch screen and/or pen input.

The example tablet computing system 340 comprises a display screen 344, one or more sensor input devices 346, and a camera 348. The example tablet computing system 340 comprises left and right input sensor devices 346a and 346b that are used as part of the sensor input system 34 described above. The camera 348 may also be used as part of the sensor input system 34. The example sensors 346 and camera 348 are embedded within the housing 342. Alternatively, the location sensors 346 may be completely invisible to the user as they may be embedded separately from the monitor housing 342. The sensor input devices 346 may also be located at the bottom of the housing, on the top and bottom of the housing, and/or at the bottom and sides of the housing.

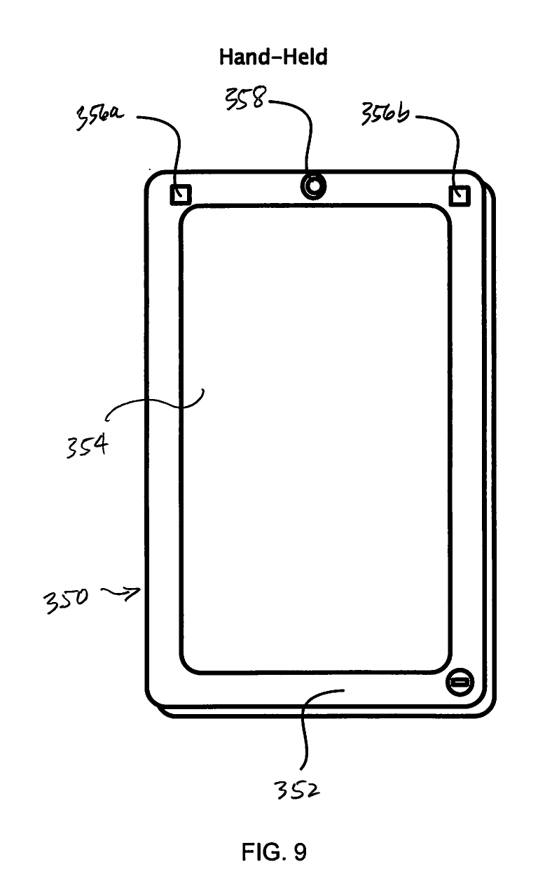

Referring now to FIG. 9, depicted therein is a handheld computing system 350 capable of implementing the 3D interface system 20 and/or interactive motion system 40 of the present invention. The example tablet computing system 350 is similar to the example tablet computer system 340 described above, but the handheld computing system 350 is typically smaller than the tablet computer system 340. The example tablet computing system 350 may offer touch screen and/or pen input.

The example handheld computing system 350 comprises a display screen 354, one or more sensor input devices 356, and a camera 358. The example handheld computing system 350 comprises left and right input sensor devices 356a and 356b that are used as part of the sensor input system 34 described above. The camera 358 may also be used as part of the sensor input system 34. The example sensors 356 and camera 358 are embedded within the housing 352. Alternatively, the location sensors 356 may be completely invisible to the user as they may be embedded separately from the monitor housing 352. The sensor input devices 356 may also be located at the bottom of the housing, on the top and bottom of the housing, and/or at the bottom and sides of the housing.

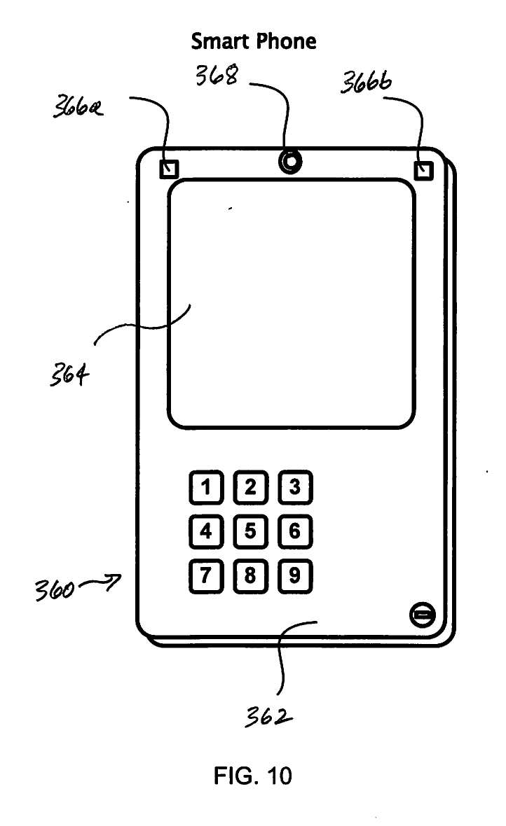

Referring now to FIG. 10, depicted therein is a smart phone computing system 360 capable of implementing the 3D interface system 20 and/or interactive motion system 40 of the present invention. The example smart phone computing system 360 is similar to the example handheld computer system 350 described above, but the smart phone computing system 360 includes cellular telecommunications capabilities not found in a typical handheld computer system. The example smart phone computing system 360 may offer touch screen and/or pen input.

The example smart phone computing system 360 comprises a display screen 364, one or more sensor input devices 366, and a camera 368. The example smart phone computing system 360 comprises left and right input sensor devices 366a and 366b that are used as part of the sensor input system 34 described above. The camera 368 may also be used as part of the sensor input system 34. The example sensors 366 and camera 368 are embedded within the housing 362. Alternatively, the location sensors 366 may be completely invisible to the user as they may be embedded separately from the monitor housing 362. The sensor input devices 366 may also be located at the bottom of the housing, on the top and bottom of the housing, and/or at the bottom and sides of the housing.

In any case described above, a projector may be used as part of the systems 20 and/or 40 described above to project a 3D image onto a screen. When using a projector, sensory input devices forming part of the sensor input system 34 may be used in a stand-alone manner (like speakers of a home entertainment center), they may be mounted on or embedded within speakers, or they may be mounted on or embedded within the projector itself.

Similarly, televisions may be configured to display 3D images, and such televisions may be used to project 3D images as part of the systems 20 and/or 40 described above. When using a television, sensor input devices forming part of the sensor input system may be mounted onto the television or embedded within it.

The 3D interface system 20 and/or interactive motion system 40 may be used in a number of different environments, and several of those environments will be described below.

It is sometimes desirable to move objects that are much too small or much too large to be moved by hand. In these situations, the interface system 30 and/or interactive motion system 40 may be used. For example an engineer or scientist may use the system to move single atoms on an object, where the 3D rendering of the physical atoms allows the engineer to ‘touch’ a single atom (or other particle) and move the atom to another location. As the engineer's hand moves the graphical representation of the atom (or a graphical representation overlaid onto a video stream of the actual atom), the engineer is able to touch and move the graphical representation of the atom using their hand (which acts as the Digital Overlay Object). A motion control system operates in sync with the engineer's hand, but does so using movements (for example distance traveled, velocity of movement and/or acceleration of movement) that are scaled to the appropriate sizing of the atom's environment, thus allowing the engineer to actually move a physical atom just as if they were moving a golf ball sitting on their desk.

Movement characteristics may be scaled individually or together as a group. For example, as a group the movement characteristics may be scaled to match those of a human but at a much smaller size (i.e. as in the case with the example of moving atoms above). Or, by altering one or more movement characteristics, the movement characteristics may be scaled to enhance the human movements. For example, the acceleration and velocity profiles may be set to double the actual capabilities of a human thus allowing a human to move twice as fast. Alternatively, these acceleration and velocity profiles may be defined by at a scale that is twice as slow so that the user can better accomplish a given task, etc.

It is also sometimes desirable to operate a motion control system remote from the user. A 3D motion interaction system of the present invention allows users to interact with a motion control system independent of the distance between the user and the motion control system. For example, a person at their office desk may operate the camera of a home security system over the internet merely by reach their hand out grabbing hold of a digital rendition of, or digital rendition overlaid onto a video image of, a camera and moving the camera to the position desired.

In another example, a scientist on earth may use the remote operation of a 3D motion interaction system of the present invention to manipulate the sensors on a remote motion control system on a different planet. For example the scientist may use the 3D Motion Interaction to grab a robotic shovel and dig samples of dirt on a remote planet or moon. The 3D Motion Interaction allows the scientist to interact with the Physical Object (in this case a robotic shovel) in a way that is similar to how they would actually use a similar physical tool that was in their immediate presence.

In another example of remote operation, a marine biologist may use the system to interact with objects sensed in the remote marine environment. For example, using location sensing technology, a remote robot could create a 3D digital overlay, that is then overlaid onto a live video feed of an underwater environment. Using the 3D motion interaction system would then allow the marine biologist to directly interact with the deep sea underwater environment as though they were there. Using such a system, a marine biologist would be able, for example, to ‘pick’ plant samples from the environment and place them into a collection basket.

The 3D motion interaction system of the present invention enhances the ability of the user to control or otherwise interact with a motion control system in a harsh environment where the user cannot go safely. For example, very deep sea depths are difficult for humans to explore because of lack of life support systems and the immense water pressures, etc. Remote vehicles are capable of operating in such environments but are typically difficult to operate. Using a 3D motion interaction of the present invention, a users hands could be mapped to the movements of side fins allowing the user to seamlessly steer the vehicle through the water by moving their hands, feet, head and/or eyes (i.e. by using a web-cam and eye tracking technology).

In another example, the 3D Motion Interaction system would allow a bomb disposal engineer to easily diffuse a bomb by directly manipulating a 3D rendition of the bomb (detected using Location Sensors) that is then projected onto a live video feed. By touching wires, etc, the 3D Motion Interactive system allows the engineer to move wires and or cut them using a robotic clipper that is mapped to the movements of the engineer's hands or other object manipulated by the engineer locally. Alternatively a complete robotic hand may be mapped to the movements of the bomb disposal engineer's hand thus allowing the engineer to directly work with the bomb as though they were directly at the scene.

In yet another example, the 3D motion interaction system would allow fire fighters to fight a fire using a remote motion control system. By mapping the movements of the fire-fighters body to the movements of the motion control system itself the fire fighter would be able to position the remote motion control system in general. And by mapping the fire fighters hands to the movements of the nozzle of a hose, he/she could gain a much finer grain, pinpoint control over where the water went to douse the fire's hot-spots, all the while doing so at a safe distance from the fire itself.

The 3D motion interaction system of the present invention further allows a user to truly live a game experience. Using the system of the present invention, the user to directly touch 3D objects in the scene around them. In addition, when touching objects that are mapped to the motions of a physical object, the user is able to directly interact with the physical world through the interface of the gaming system. For example, using a 3D motion interaction system of the present invention, the hand movements of one user can be mapped to a remote robotic hand, thereby allowing the user to shake the physical hand of a remote user via a video phone link.

A 3D motion interaction system of the present invention is also very useful when used with remote motion control systems that operate wirelessly or wired yet in a near proximity to the 3D motion interaction system. For example, the 3D motion interaction system is an ideal technology for auto mechanics where a small motion control system is used to enter into difficult to reach locations under the hood of an automobile or truck. Once at a trouble spot, the mechanic is then able to use the 3D motion interaction system to fix the problem at hand directly without requiring engine extraction or a more expensive repair procedure in which the main expense is attributed to just getting to the problem area. In such a situation, the mechanic's hand may be mapped to the motions of a wrench, or, alternatively, the mechanic may use his hand to move a digital overlay of a wrench which then in turn moves a physical wrench.

In another example, the 3D motion interaction system of the present invention may be used in the medical profession to install a heart stint, repair an artery, or perform some other remote medical procedure such as surgery. There are several ways such technology may be used.

In a first example of a medical procedure using the 3D motion interaction system of the present invention, a real-time magnetic resonance imaging of the person to be operated on is overlaid onto a live video of the person. Using Location Sensors or the MRI data itself, the depth and position information is then used to form the digital 3D information used to perform collision detection against a physicians hand, knife, or cauterizing tool used during surgery. Using the 3D Motion Interaction interface, the surgeon is then able to perform the surgery on a 3D rendition of the patient, all the while allowing a motion control system to perform the actual surgery.

In a second example medical procedure, the 3D motion interaction system is used to manipulate miniature tools such as those typically mounted at the end of an endoscope used when performing a colonoscopy. Instead of viewing such information on a 2D video screen, the physician would instead directly manipulate the tissue (such as remove cancerous polyps) by moving the extraction tools directly using their hands by directly manipulating the digital overlay of the extraction tool. The physician would actually see the 3d live video of the extraction tool, as the digital overlay may be invisible—yet when ‘touching’ the extraction tool, the tool would move making it appear to the physician as thought he or she had directly moved the extraction tool. Taken a step further with multiple ‘touches’ from multiple fingers, the physician would feel as though they were directly manipulating the extraction tool using their hands, when in reality there were merely manipulating the invisible digital overlay, that was then, through collision detection, directing the motion control system how to move through its mapped axes of motion by directing the motion system to correct its current position by moving to the tangent ‘touch’ point(s) calculated using the collision detection, the digital rendition of the other objects (the objects touched) and the digital overlay of the sensed object.

From the foregoing, it should be apparent that the present invention may be embodied in forms other than those described above. The scope of the present invention should thus be determined by the claims appended hereto and not the foregoing detailed description.

What is claimed is:

1. A 3D interface system comprising:
a display system for displaying 3D images;
a sensor input system, where the sensor input system generates sensor data associated with at least one physical control object; and
a computing system for receiving the sensor data and causing the display system to display
at least one digital displayed object, and
at least one digital sensed object associated with the at least one physical object; whereby
the computing system moves the at least one digital displayed object based on movement of the at least one physical object.

2. A 3D interface system as recited in claim 1, in which:
the sensor input system defines a sensor field of view; and
the 3D images generated by the display system are associated with the sensor field of view.

3. A 3D interface system as recited in claim 2, in which the user views the 3D images generated by the display system through the sensor field of view.

4. A 3D interface system as recited in claim 2, in which the user views the 3D images generated by the display system within the sensor field of view.

5. A 3D interface system as recited in claim 4, in which at least one digital sensed object is a digital overlay object overlaid over at least one physical object associated with the digital overlay object.

6. An interactive motion system comprising:
a display system for displaying 3D images;
a sensor input system, where the sensor input system generates sensor data associated with at least one physical controlled object and at least one physical control object;
a computing system for receiving the sensor data and causing the display system to display
at least one digital displayed object associated with the at least one physical controlled object, and
at least one digital sensed object associated with the at least one physical control object; and
a motion control system; whereby
the motion control system moves the at least physical controlled object based on movement of the at least one physical control object.

7. An interactive motion system as recited in claim 6, in which:
the sensor input system defines a sensor field of view; and
the 3D images generated by the display system are associated with the sensor field of view.

8. An interactive motion system as recited in claim 7, in which the user views the 3D images generated by the display system through the sensor field of view.

9. An interactive motion system as recited in claim 7, in which the user views the 3D images generated by the display system within the sensor field of view.

10. An interactive motion system as recited in claim 9, in which at least one digital sensed object is a digital overlay object overlaid over at least one physical object associated with the digital overlay object.

11. A method of moving at least one physical controlled object comprising the steps of:
generating sensor data associated with the at least one physical controlled object and the at least one physical control object;
displaying a 3D image comprising
at least one digital displayed object associated with the at least one physical controlled object, and
at least one digital sensed object associated with at least one physical control object;
moving the at least physical controlled object based on movement of the at least one physical control object.

12. A method as recited in claim 11, further comprising the step of displaying the 3D image through a sensor field of view.

13. A method as recited in claim 11, further comprising the step of displaying the 3D image within a sensor field of view.

14. A method as recited in claim 11, further comprising the step of overlaying a digital overlay object over at least one physical object associated with the digital overlay object.
